(19) United States
(12) Patent Application Publication
(10) Pub. No.: US 2019/0105844 A1
(43) Pub. Date: Apr. 11, 2019

(54) Method for Automatic Creation of Cutting Paths in Interior Space of Three-Dimensional Shaped Product

(71) Applicant: Matsuura Machinery Corporation, Fukui City (JP)

(72) Inventors: Satoru Tarumi, Fukui City (JP); Jun Kobayashi, Fukui City (JP)

(21) Appl. No.: 16/193,376

(22) Filed: Nov. 16, 2018

Related U.S. Application Data
(63) Continuation-in-part of application No. 15/876,542, filed on Jan. 22, 2018.

(30) Foreign Application Priority Data
Aug. 7, 2017 (JP) 2017-152521

(51) Int. Cl. B29C 64/393; B29C 64/153; B33Y 10/00; B33Y 50/02

(52) U.S. Cl. CPC B29C 64/393; B33Y 50/02; B33Y 10/00; B29C 64/153

(57) ABSTRACT

A method for automatic creation of a cutting path in an interior space of a three-dimensional shaped product formed in a CAD/CAM system, includes the steps of separately forming an upper region and a lower region by lamination and sintering; defining a horizontal plane at an intermediate location between an upper end of the lower region and a lower end of the upper region; first creating, on the interior wall sections of the lower region below the horizontal plane, data of horizontal cutting paths; then second creating data, on the interior wall sections of the upper region above the horizontal plane, data of horizontal cutting paths; placing the upper region on the lower region at a position of the horizontal plane; and joining the cutting paths of the upper and lower regions at the horizontal plane in order to form the three-dimensional shaped product.

### BACKGROUND OF THE INVENTION

### Technical Field

The present invention relates to a method for automatically creating horizontal cutting paths in the interior space of a three-dimensional shaped product, using a CAD/CAM system in which a program is designed for each of the steps of: forming lamination of a powder according to a squeegee spraying the powder and moving on the sprayed powder for making the powder surface into a flat state, sintering by radiating one of a laser beam and an electron beam to one or a plurality of the laminated powder layers in a shaping region of the three-dimensional shaped product by melting radiated positions and solidifying the radiated positions after melting, and cutting by traveling of a cutting tool, that are necessary to produce a three-dimensional shaped product.

### Background Art

When creating a cutting path for a cutting tool by a CAD/CAM system, it is assumed that the regions containing the cutting path are regions in which the cutting tool can be inserted.

For an enclosed interior space of a three-dimensional shaped product, therefore, such as the inner side of a water conduit, it is considered to be impossible to automatically create a cutting path in the interior space by a CAD/CAM system, under a reason that the cutting tool cannot be inserted essentially.

In light of this problem, Patent Document 1 proposes irradiating a laser light beam for interior cutting of a three-dimensional shaped product by a CAD/CAM system while adjusting the focal point of the light beam, to thereby avoid having to use a cutting tool to create a cutting path in the interior space.

On the other hand, in other prior art different from Patent Document 1, a horizontal plane is first established at a location at the upper end of the interior space, the shaping region is divided into a region above the plane and a region below the plane, the CAD/CAM system is used to create the horizontal cutting paths in the upper region and the lower region, and the cutting paths of both are joined after deleting the cutting path automatically created on the plane.

However, in this method, each horizontal cutting path in the upper region and each horizontal cutting path in the lower region are separately and independently created, and as a result it is impossible for the CAD/CAM system to automatically create a program combining the cutting paths of both, since the regions do not have the parameters based on common information.

That is, in order to accomplish such joining, it is necessary to create the program manually.

According to the prior art, therefore, no method has been provided for automatic creation of horizontal cutting paths by a CAD/CAM system for cutting of the interior spaces of three-dimensional shaped products.

### PRIOR ART DOCUMENT

### [Patent Document]

### [Patent Document 1] USP No. 2002/0100750 A1

### SUMMARY OF INVENTION

### Technical Problem

An object of the present invention is providing a construction allowing automatic creation of horizontal cutting paths which are necessary for cutting in the interior space of a three-dimensional shaped product with a CAD/CAM system.

### Solution to Problem

In order to solve the aforementioned problems, the present invention has the following basic features.

(1). A method for automatic creation of a cutting path in an interior space of a three-dimensional shaped product formed in a CAD/CAM system in which a program is designed for each of the steps of forming lamination of a powder according to a squeegee spraying the powder and moving on the sprayed powder for making the powder surface in a flat state, sintering by radiating one of a laser beam and an electron beam to one or a plurality of the laminated powder layers in a shaping region of the three-dimensional shaped product by melting radiated positions and solidifying the radiated positions after melting and cutting by traveling of a cutting tool, that are necessary to create the three-dimensional shaped product, comprising the steps of:

defining a horizontal plane at an intermediate location between an upper end and a lower end of the interior space,

first creating, in a lower region of the horizontal plane, data of horizontal cutting paths with a standard on positions according to a height direction on interior wall sections, that are set by the program for said steps of forming lamination and sintering, from a location at the lower end or a vicinity of the lower end, at locations set successively toward an upper side with every cutting width of the cutting tool along a vertical direction,

when creation of each horizontal cutting path described in the step of first creating has reached the horizontal plane or a location at a distance that is shorter than the cutting width along the vertical direction from the horizontal plane, while stopping creation of the horizontal cutting path at the horizontal plane, thereafter second creating data of horizontal cutting paths with a standard on positions according to a height direction on interior wall sections, that are set by the program for said steps of forming lamination and sintering, in the upper region of the horizontal plane, at locations set successively toward the upper side with every cutting width of the cutting tool along the vertical direction, from a location that is higher by the cutting width than the last cutting path created in the step of first creating, until reaching the upper end or a vicinity of the upper end,

joining the cutting paths of the step of first creating and the cutting paths of the step of second creating through the horizontal plane,

wherein, for forming the three-dimensional shaped product, it is planned that the lower region of the horizontal plane and the upper region of the horizontal plane are divided with each other, and the forming lamination, the sintering, and the cutting of the lower region and these of the upper region are executed independently, and that the upper region is put on the lower region at a position of the horizontal plane, and these regions are connected with each other by radiating one of a laser beam and an electron beam from outside to a position of the horizontal plane and its neighborhood by melting the position and solidifying the position after melting.

(2). A method for automatic creation of a cutting path in an interior space of a three-dimensional shaped product formed in a CAD/CAM system in which a program is designed for each of the steps of forming lamination of a powder according to a squeegee spraying the powder and moving on the sprayed powder for making the powder surface in a flat state, sintering by radiating one of a laser beam and an electron beam to one or a plurality of the laminated powder layers in a shaping region of the three-dimensional shaped product by melting radiated positions and solidifying the radiated positions after melting and cutting by traveling of a cutting tool, that are necessary to create the three-dimensional shaped product, comprising the steps of:

defining a horizontal plane at an intermediate location between an upper end and a lower end of the interior space,

first creating, in a lower region of the horizontal plane, data of horizontal cutting paths with a standard on positions according to a height direction on interior wall sections, that are set by the program for said steps of forming lamination and sintering, from a location at the lower end or a vicinity of the lower end, at locations set successively toward an upper side with every cutting width of the cutting tool along a vertical direction,

when creation of each horizontal cutting path in the step of first creating has reached the horizontal plane or a location at a distance that is shorter than the cutting width along the vertical direction from the horizontal plane, while creating a horizontal cutting path on the horizontal plane, thereafter second creating data of horizontal cutting paths with a standard on positions according to a height direction on interior wall sections, that are set by the program for said steps of forming lamination and sintering, in the upper region of the horizontal plane, at locations set successively toward the upper side with every cutting width of the cutting tool along the vertical direction, from a location that is higher by the cutting width than the last cutting path created in the step of first creating, until reaching the upper end or a vicinity of the upper end,

joining the cutting paths of the step of first creating and the cutting paths of the step of second creating through the horizontal plane, after deleting the horizontal cutting path on the horizontal plane,

wherein, for forming the three-dimensional shaped product, it is planned that the lower region of the horizontal plane and the upper region of the horizontal plane are divided with each other, and the forming lamination, the sintering, and the cutting of the lower region and these of the upper region are executed independently, and that the upper region is put on the lower region at a position of the horizontal plane, and these regions are connected with each other by radiating one of a laser beam and an electron beam from outside to a position of the horizontal plane and its neighborhood by melting the position and solidifying the position after melting.

### Advantageous Effects of Invention

For forming the three-dimensional shaped products, the present invention, as is founded on these basic constructions (1) and (2), stands on the premise to be planned that the lower region of the horizontal plane and the upper region of the horizontal plane are divided with each other, and the lamination, the sintering, and the cutting of the lower region and these of the upper region are executed independently, and that the upper region is put on the lower region at a position of the horizontal plane, and these regions are connected with each other by radiating one of a laser beam and an electron beam from outside to a position of the horizontal plane and its neighborhood by melting the position and solidifying the position after melting.

According to the above premise, the present invention specifies the location for a lower region and upper region created by a CAD/CAM system on a conceptually defined horizontal plane, and the CAD/CAM system can therefore automatically join the lower region and upper region through the specified location, while the programs that create the horizontal cutting paths in both regions can be automatically joined, and so it is unnecessary to further manually create a special program for joining, as is the case of the prior art.

Moreover, in the present invention, since the lower region and the upper region can be joined through the horizontal plane without any special deformation, it is possible to carry out high-quality cutting of the interior.

### BRIEF DESCRIPTION OF DRAWINGS

FIGS. 1(a) and 1(b) are a pair of lateral cross-sectional views illustrating the process of Example 1, with FIG. 1(a) showing the state before inversion in the vertical direction, and FIG. 1(b) showing the state after inversion in the vertical direction.

FIGS. 2(a) and 2(b) are a pair of lateral cross-section views illustrating the process of Example 2, with FIG. 2(a) showing the state before rotational coordinate transformation, and FIG. 2(b) showing the state after the coordinate transformation.

FIGS. 3(a), 3(b), 3(c) and 3(d) are a set of lateral cross-section views illustrating the process of the basic construction (1), with FIG. 3(a) showing step 1, FIG. 3(b) showing step 2, FIG. 3(c) showing step 3 and FIG. 3(d) showing step 4 (where the “x” symbols indicate the height locations of horizontal cutting paths, and the thick solid lines indicate the cutting paths on the lower end surface and upper end surface).

FIGS. 4(a), 4(b), 4(c) and 4(d) are a set of lateral cross-section views illustrating the process of the basic construction (2), with FIG. 4(a) showing step 1, FIG. 4(b) showing step 2, FIG. 4(c) showing step 3 and FIG. 4(d) showing step 4 (where the “x” symbols indicate the height locations of horizontal cutting paths, and the thick solid line indicates the horizontal cutting path at the horizontal plane).

FIGS. 5(a), 5(b), 5(c) and 5(d) are a set of lateral cross-section views illustrating the planned process of the basic constructions (1) and (2) for forming the three-dimensional shaped products, with FIG. 5(a) showing the step of forming lamination of the powder and sintering in the lower region and the upper region independently after these regions are divided with each other, FIG. 5(b) showing the step of cutting in the lower region and the upper region independently, FIG. 5(c) showing the step of putting the upper region on the lower region and FIG. 5(d) showing the step of radiating one of the laser beam and the electron beam from outside to the position of the horizontal plane and its neighborhood.

FIGS. 6(a) and 6(b) are a set of an embodying drawing of FIG. 5(d) in which one additional one of a laser beam and an electron beam radiating instrument is provided as equipment outside of the horizontal plane for radiating the position of the horizontal plane and its neighborhood and the lower region and the upper region are positioned on a table which may rotate along center axis, with FIG. 6(a) showing a partial lateral cross-section view and a partial side view, and FIG. 6(b) showing an upper side view.

FIGS. 7(a) and 7(b) are a set of an embodying drawing of FIG. 5(d) in which one mirror is equipped outside of the horizontal plane for reflecting one of the laser beam and the electron beam by an instrument for sintering to the position of the horizontal plane and its neighborhood and that the lower region and the upper region are positioned on a table which may rotate along a center axis, with FIG. 7(a) showing a partial lateral cross-section view and a partial side view, and FIG. 7(b) showing an upper side view.

FIGS. 8(a) and 8(b) are a set of an embodying drawing of FIG. 5(d) in which 3 additional one of a laser beam and an electron beam radiating instruments are equipped outside of the horizontal plane with identical angled position along the horizontal direction around a center axis along a perpendicular direction of the lower region and the upper region for radiating the position of the horizontal plane and its neighborhood, and each one of the 3 laser beam and the electron beam radiating instruments rotates along a horizontal direction with an angle range of 120°, with FIG. 8(a) showing a partial lateral cross-section view and a partial side view, and FIG. 8(b) showing upper side views.

FIGS. 9(a) and 9(b) are a set of an embodying drawing of FIG. 5(d) in which 3 mirrors are equipped outside of the horizontal plane with identical angled positions along the horizontal direction around a center axis along a perpendicular direction of the lower region and the upper region for reflecting one of the laser beam and the electron beam by an instrument for sintering to the position of the horizontal plane and its neighborhood in order and that each of the 3 mirrors rotates along the horizontal direction with an angle range of 120°, with FIG. 9(a) showing a partial lateral cross-section view and a partial side view, and FIG. 9(b) showing an upper side view.

### DESCRIPTION OF EMBODIMENTS

The basic constructions (1) and (2) stand on that a CAD/CAM system automatically creates a program for each step necessary to produce a three-dimensional shaped product 1, based on the steps of laminating a powder with a traveling squeegee, sintering by irradiation of a laser beam or electron beam and cutting by traveling of a cutting tool, while the fundamental technical concept of the basic constructions (1) and (2) exist in automatically creating horizontal cutting paths 5 necessary for cutting of the three-dimensional shaped product 1 in the interior space 2.

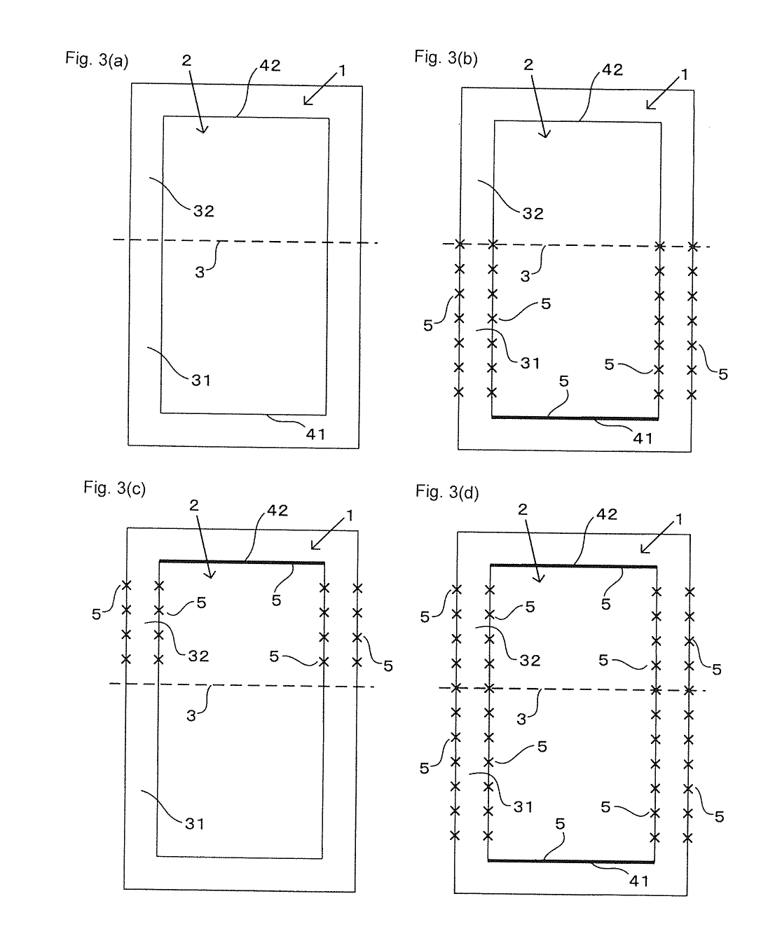

The basic construction (1) comprises the order of steps specified below, as illustrated in FIGS. 3(a)-3(d), by which cutting paths 5 are automatically created in the wall sections of the interior space 2.

1. As shown in FIG. 3(a), a horizontal plane 3 is defined at an intermediate location between the upper end and the lower end of the interior space 2.

2. As shown in FIG. 3(b), in the lower region 31 of the horizontal plane 3, data of horizontal cutting paths 5 with a standard on positions according to a height direction on interior wall sections, are set by the program for said steps of forming lamination and sintering, from a location at the lower end or its vicinity, at locations set successively toward the upper side with every cutting width of the cutting tool along a vertical direction.

3. As shown in FIG. 3(c), when creation of horizontal cutting paths 5 described in step 2 has reached the horizontal plane 3 or a location at a distance that is shorter than the cutting width along the vertical direction from the horizontal plane 3, while stopping creation of the horizontal cutting path 5 at the horizontal plane 3, thereafter second creating data of horizontal cutting paths 5 with a standard on positions according to a height direction on interior wall sections, that are set by the program for said steps of forming lamination and sintering, in the upper region 32 of the horizontal plane 3, at locations set successively toward the upper side with every cutting width of the cutting tool along the vertical direction, from a location that is higher by the cutting width than the last cutting path 5 created in step 2, until reaching the upper end or its vicinity.

4. As shown in FIG. 3(d), the cutting paths 5 of step 2 and the cutting paths 5 of step 3 are joined through the horizontal plane 3.

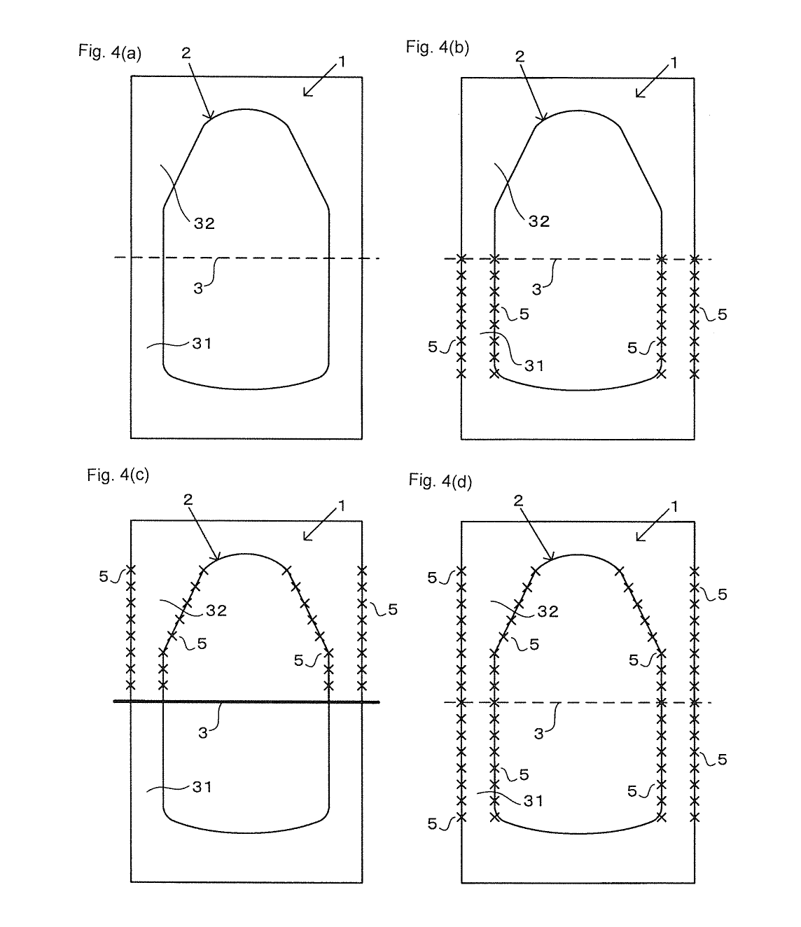

The basic construction (2) comprises the order of steps specified below, as illustrated in FIGS. 4(a)-4(d), by which cutting paths 5 are automatically created in the wall sections of the interior space 2.

1. As shown in FIG. 4(a), a horizontal plane 3 is defined at an intermediate location between the upper end and the lower end of the interior space 2.

2. As shown in FIG. 4(b), in the lower region 31 of the horizontal plane 3, data of horizontal cutting paths 5 with a standard on positions according to a height direction on the interior wall sections, are set by the program for said steps of forming lamination and sintering, from a location at the lower end or its vicinity, at locations set successively toward the upper side with every cutting width of the cutting tool along a vertical direction.

3. As shown in FIG. 4(c), when creation of horizontal cutting paths 5 described in step 2 has reached the horizontal plane 3 or a location at a distance that is shorter than the cutting width along the vertical direction from the horizontal plane 3, while creating a horizontal cutting path 5 on the horizontal plane 3, thereafter second creating data of horizontal cutting paths 5 with a standard on positions according to the height direction on interior wall sections, that are set by the program for said steps of forming lamination and sintering, in the upper region 32 of the horizontal plane 3, at locations set successively toward the upper side with every cutting width of the cutting tool along the vertical direction, from a location that is higher by the cutting width than the last cutting path 5 created in step 2, until reaching the upper end or its vicinity.

4. As shown in FIG. 4(d), after deleting the horizontal cutting path 5 on the horizontal plane 3, the cutting paths 5 of step 2 and the cutting paths 5 of step 3 are joined through the horizontal plane 3.

In both step 2 and step 3, the horizontal cutting paths 5 are automatically created for interior wall sections set by the program required to carry out the lamination or sintering of one or a plurality of layers as a unit.

In steps 2 and 3, the horizontal cutting paths 5 are set at locations successively toward the upper side with different tool cutting widths in the vertical direction, and the height locations of the horizontal cutting paths 5 are specified based on specific locations in the widths in the vertical direction.

However, the center location of the widths in the vertical direction will usually be set to be the reference location for the horizontal cutting paths 5.

As shown in FIG. 3(b) and FIG. 3(c), and FIG. 4(b) and FIG. 4(c), the horizontal cutting paths 5 at each height location on the interior wall section and horizontal cutting paths 5 at each height location on the outer wall sections are created, but it may be optionally selected whether to create the horizontal cutting paths 5 on the interior wall sections before the horizontal cutting paths 5 on the outer wall sections, or in the opposite order.

In step 3, the horizontal cutting paths 5 created at the uppermost location in the lower region 31 of the horizontal plane 3 are either at a location at the same height as the horizontal plane 3, or at a location with a shorter distance than the cutting width in the vertical direction, along the height direction, with respect to the plane.

In either case, in step 3, the horizontal cutting paths 5 shift to the upper region 32 and are created at locations set successively toward the upper side with every cutting width of the cutting tool along the vertical direction.

In the basic construction (1), the CAD/CAM system cancels creation of the cutting path 5 in the horizontal plane 3, but in the basic construction (2), the cutting path 5 of the horizontal plane 3 is created and then deleted afterwards.

Thus, the basic construction (1) is more efficient than the basic construction (2), in terms of unnecessity for creating and deleting the horizontal cutting path 5 on the horizontal plane 3.

However, in either case, the CAD/CAM system specifies and records the location of the horizontal plane 3, and depending on that location, step 4 can still be automatically carried out in either case as long as it is possible to create a combining program obtained from the program that creates the horizontal cutting paths 5 in the upper region 32 and the program that creates the horizontal cutting paths 5 in the lower region 31.

In the basic constructions (1) and (2), it must be examined why the program may create horizontal cutting paths 5 on the interior wall sections.

For reference, inserting a cutting tool in interior space 2 seems to be impossible.

However, in basic constructions (1) and (2), the program may create horizontal cutting paths 5 on the interior wall according to following steps:

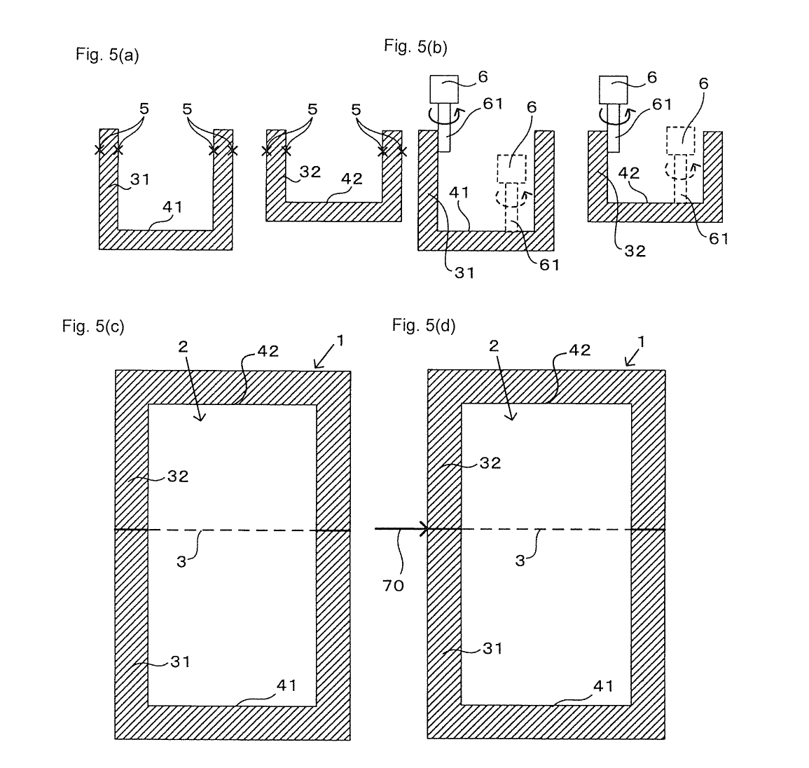

(1). As shown in FIG. 5(a), the lower region 31 of the horizontal plane and the upper region 32 of the horizontal plane 3 are divided with or separated from each other, and the forming lamination and the sintering are executed in the lower region 31 and the upper region 32 independently.

(2). As is shown in FIG. 5(b), the cutting of the lower region 31 and the upper region 32 are executed independently, in other words, cutting tool 6 with rotational axis 61 may be inserted into the divided lower region 31 and the upper region 32 of divided state, because the lower region 31 and the upper region 32 have an open space according to the divided process of above (1),

(3). As shown in FIG. 5(c), the upper region 32 is put on the lower region 31 at a position of the horizontal plane.

Putting the upper region 32 on the lower region 31 is possible, because the lower region 31 has a flat plane along the horizontal plane 3 with a certain area at the upper end, and the upper region 32 has a flat plane along the horizontal plane 3 with a certain area at the lower end.

(4). As shown in FIG. 5(d), the lower region 31 and the upper region 32 are connected with each other by radiating one of a laser beam and an electron beam from outside to a position of the horizontal plane 3 and its neighborhood by melting the position and solidifying the position after melting.

A concrete construction of radiating one of a laser beam and an electron beam disclosed in FIG. 5(d) is explained according to the following embodiments:

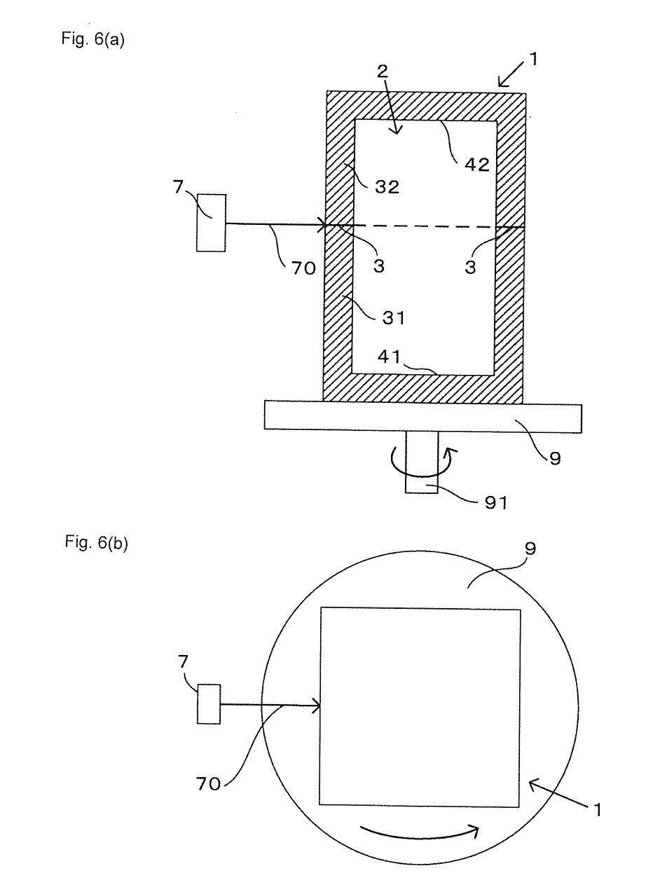

FIG. 6(a) and FIG. 6(b) denote an embodiment of construction denoted by FIG. 5(d) in which one additional one of a laser beam and an electron beam 70 radiating instrument 7 is equipped for radiating the position of the horizontal plane 3 and its neighborhood from outside of the horizontal plane 3 besides one of the laser beam and the electron beam 70 radiating instrument 7 for sintering and that the lower region 31 and the upper region 32 with connecting state are positioned on a table 9 which may rotate along center axis 91 to execute radiation for all positions of the horizontal plane 3 and its neighborhood.

In the embodiment of FIG. 6(a) and FIG. 6(b), one additional radiating instrument 7 for radiating one of a laser beam and an electron beam 70 besides one of the laser beam and the electron beam 70 radiating instrument 7 for sintering is necessary.

However, according to rotation of the table 9 along center axis 91, all positions of the horizontal plane 3 and its neighborhood can be radiated by one additional instrument 7 with radiation, so the lower region 31 and the upper region 32 are connected with each other.

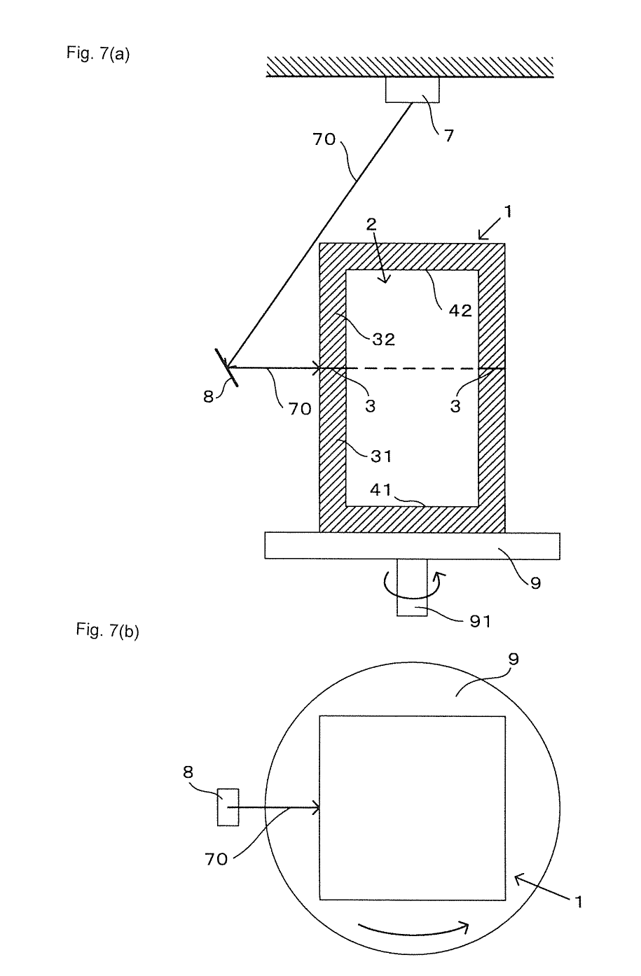

FIG. 7(a) and FIG. 7(b) designate embodiment in which one mirror 8 is equipped for reflecting one of the laser beam and the electron beam 70 by radiating instrument 7 for sintering to the position of horizontal plane 3 and its neighborhood from outside of the horizontal plane 3 and that the lower region 31 and the upper region 32 with connecting state are positioned on a table 9 which may rotate along center axis 91 to execute radiation for radiating all positions of the horizontal plane 3 and its neighborhood.

In embodiments of FIG. 7(a) and FIG. 7(b), one of the laser beam and the electron beam 70 by the instrument 7 for can be reflected by one mirror 8 to the horizontal plane 3 and its neighborhood, and according to the rotation of the table 9 along the center axis 91, all positions of the horizontal plane 3 and its neighborhood can be radiated by one mirror 8, and so the lower region 31 and the upper region 32 are connected with each other.

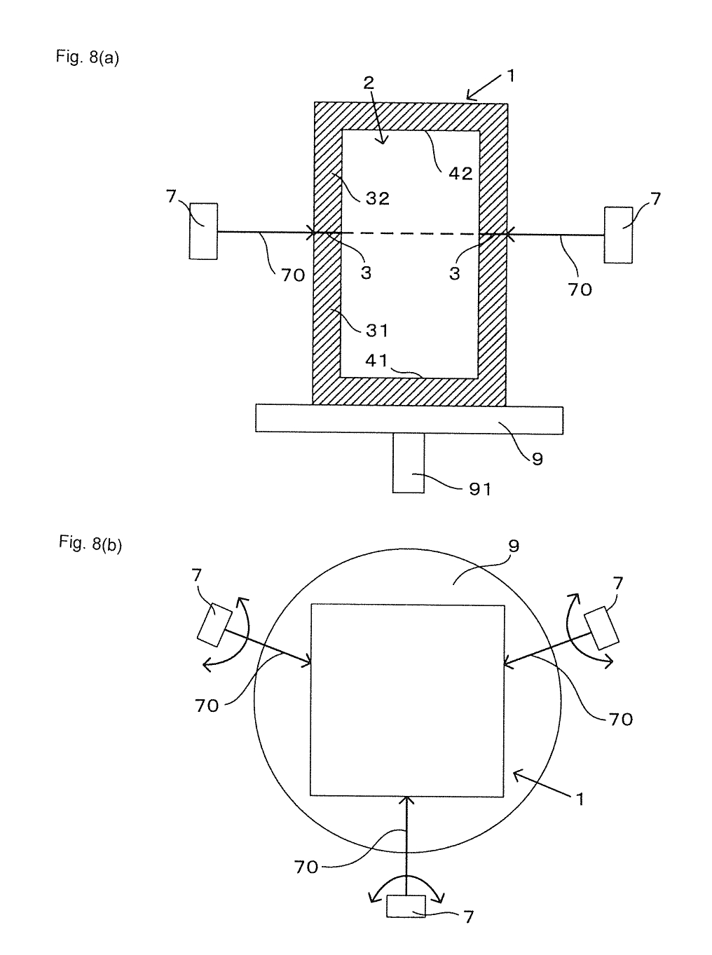

FIG. 8(a) and FIG. 8(b) designate an embodiment in which plural numbers N of laser beam and electron beam 70 radiating instruments 7 are equipped for radiating the position of the horizontal plane 3 and its neighborhood outside of the horizontal plane 3 with an identical angled position along the horizontal direction around center axis 91 along perpendicular direction of the lower region 31 and the upper region 32 besides one of the laser beam and the electron beam 70 radiating instrument 7 for sintering with state of N≥3, and that each plural numbers N of one of the laser beam and the electron beam 70 radiating instruments 7 rotates along horizontal direction with an angle range of 360°/N.

In the embodiment of FIG. 8(a) and FIG. 8(b), it is necessary to equip numbers N of instruments 7 for radiating a laser beam and an electron beam 70 besides instruments 7 for sintering.

However, according to rotation of numbers N of instruments 7 for radiating the laser beam and the electron beam 70 with an angle range of 360°/N, all positions of the horizontal plane 3 and its neighborhood can be radiated by numbers N of instruments 7 without rotation of the table 9, and so the lower region 31 and the upper region 32 are connected with each other.

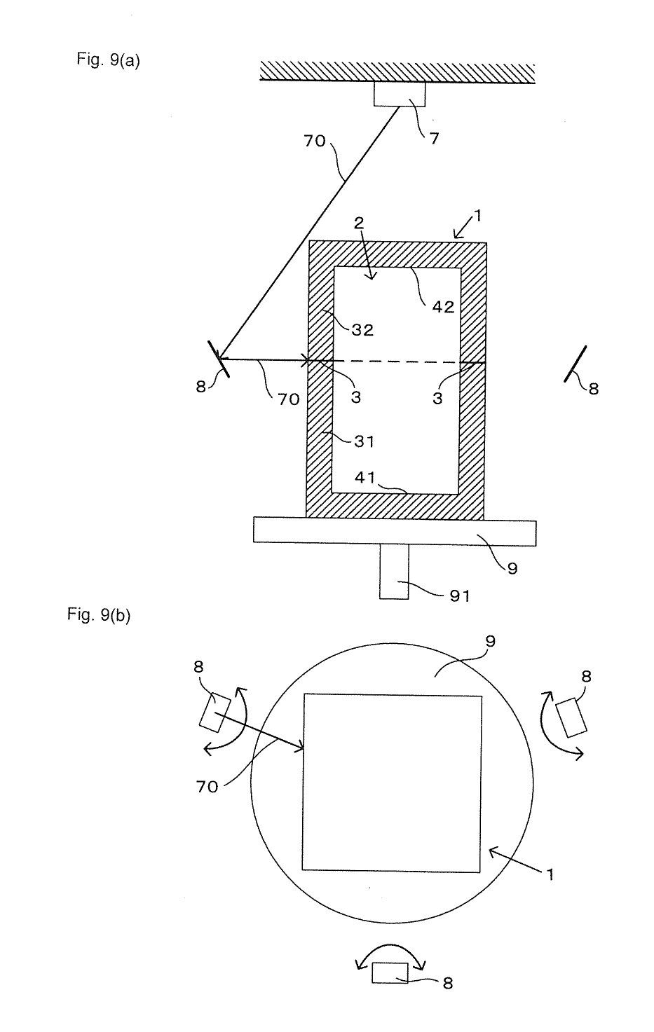

FIG. 9(a) and FIG. 9(b) designate an embodiment in which plural numbers N of mirrors 8 are equipped for reflecting one of the laser beam and the electron beam 70 by radiating instrument 7 for sintering to the position of horizontal plane 3 and its neighborhood from outside of the horizontal plane in order with identical an angled position along the horizontal direction around center axis 91 along a perpendicular direction of the lower region 31 and the upper region 32 with a state of N≥3 and that each plural numbers N of the mirrors 8 rotates along the horizontal direction with an angle range of 360°/N.

In the embodiment of FIG. 9(a) and FIG. 9(b), it is necessary to equip numbers N of mirrors 8 for reflecting the laser beam or electron beam 70 by the radiating instrument 7 for sintering.

However, according to rotation of numbers N of mirrors 8 with an angle range of 360°/N, all positions of the horizontal plane 3 and its neighborhood can be radiated by numbers N of instruments 7 without rotation of the table 9, and so the lower region 31 and the upper region 32 are connected with each other.

In the interior space 2, it is planned that a lower end surface 41 of the lower region 31 and an upper end surface 42 of the upper region 32 are formed by the forming lamination and the sintering as is disclosed in FIG. 5(a) after dividing the lower region 31 and the upper region 32.

Moreover, it is planned that in the lower end surface 41 of the lower region 31 and the upper end surface 42 of the upper region 32, cutting by a top position of rotational axis 61 of cutting tool 6 may be executed as is disclosed by the dotted line in FIG. 5(b).

Especially, it may be planned that cutting for the upper end surface 42 of the upper region 32 is executed after inverting the upper end locations and the lower end locations as is denoted by FIG. 5(b).

Examples of the invention will now be described.

### Example 1

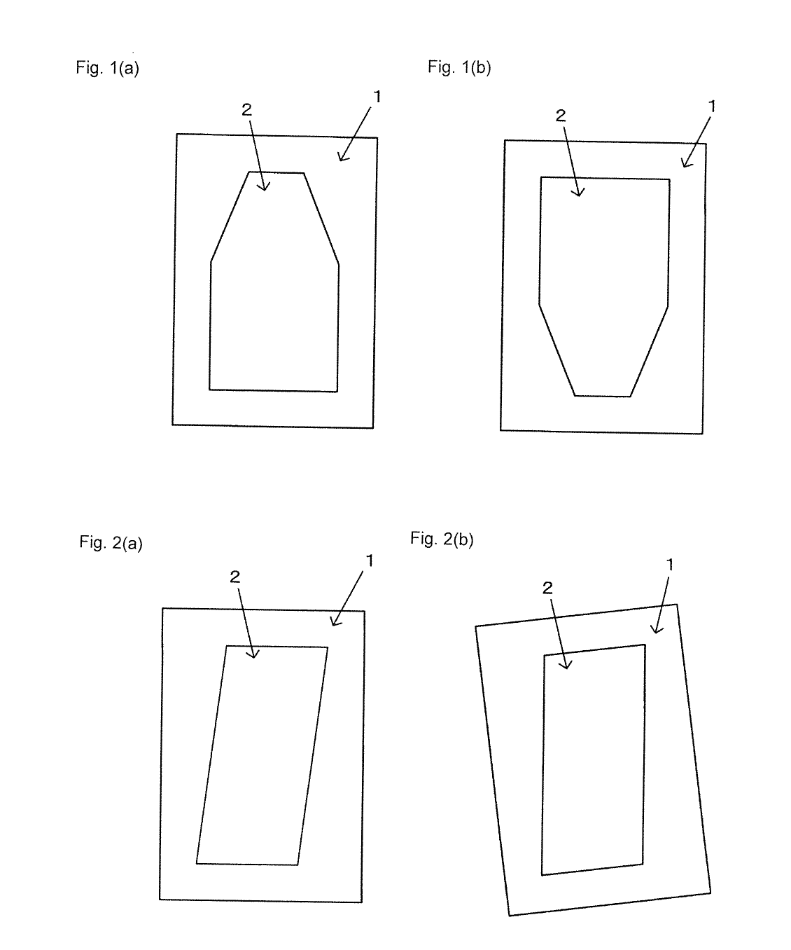

In Example 1, as shown in FIGS. 1(a) and 1(b), when the shape is comprised in that the horizontal direction width of the interior wall section gradually narrows along the upward direction in a partial region in the vertical direction, while the interior wall section is vertical at the other height regions, the horizontal cutting paths 5 in each of the steps 1, 2, 3 and 4 are created after inverting the upper end locations and the lower end locations.

In Example 1, a portion of the region along the height direction of the interior wall section narrows toward the upper end, as shown in FIGS. 1(a) and 1(b), and while such a case has conventionally required the use of an undercut tool, since the other regions along the height direction are in the vertical direction, inversion of the lower end and upper end allows a program to be automatically created assuming the use of a standard cutting tool for the horizontal cutting paths 5, thus contributing to more efficient creation of the cutting paths 5.

### Example 2

In Example 2, as shown in FIGS. 2(a) and 2(b), when the facing interior wall sections are in a parallel slanting state in all of the regions along the vertical direction, the horizontal cutting paths 5 in each of steps 1, 2, 3 and 4 are created after carrying out coordinate transformation from the slanting direction to the vertical direction in all of the regions of the three-dimensional shaped product 1.

The use of an undercut tool for slanted interior wall sections has conventionally been unavoidable, but in Example 2, the mutually facing interior wall sections are slanted in a parallel manner along the height direction, and therefore by coordinate transformation with an angle shift so that the direction of inclination is vertical, therefore it is possible to create the cutting paths 5 with the premise that a standard tool will be used for all of the regions, thus allowing the cutting paths 5 to be created in a more efficient manner.

### INDUSTRIAL APPLICABILITY

The present invention carries out full automation of horizontal cutting paths in the interior space of a three-dimensional shaped product using a CAD/CAM system, and it can therefore be utilized in a wide range of three-dimensional shaping processes in which creation of interior spaces is indispensable.

### REFERENCE SIGNS LIST

1: Three-dimensional shaped product
2: Interior space
3: Horizontal plane
31: Lower region
32: Upper region
41: Lower end surface
42: Upper end surface
5: Cutting path
6: Cutting tool
61: Rotational axis
7: Instrument for radiating one of laser beam or electron beam
70: One of laser beam or electron beam
8: Mirror
9: Table
91: Center axis

What is claimed is:

1. A method for automatic creation of a cutting path in an interior space of a three-dimensional shaped product formed in a CAD/CAM system in which a program is designed for each of the steps of forming lamination of a powder according to a squeegee spraying the powder and moving on the sprayed powder for providing the powder surface flat state, sintering by radiating one of a laser beam and an electron beam to one or a plurality of the laminated powder layers in a shaping region of the three-dimensional shaped product by melting radiated positions and solidifying the radiated positions after melting and cutting by traveling of a cutting tool, that are necessary to create the three-dimensional shaped product having an interior space, comprising the steps of:
separately forming an upper region and a lower region of the three-dimensional shaped product by said lamination and sintering,
defining a horizontal plane at a position separating the upper region and the lower region,
first creating, in the lower region below the horizontal plane, data of horizontal cutting paths with a standard on positions according to a height direction on interior wall sections, that are set by the program for said steps of forming lamination and sintering, from a location at the lower end or a vicinity of the lower end, at locations set successively toward an upper side with every cutting width of the cutting tool along a vertical direction,
when creation of each horizontal cutting path described in the step of first creating has reached the horizontal plane or a location at a distance that is shorter than the cutting width along the vertical direction from the horizontal plane, while stopping creation of the horizontal cutting path at the horizontal plane, thereafter second creating data of horizontal cutting paths with a standard on positions according to a height direction on interior wall sections, that are set by the program for said steps of forming lamination and sintering, in the upper region above the horizontal plane, at locations set successively toward the upper side with every cutting width of the cutting tool along the vertical direction, from a location that is higher by the cutting width than the last cutting path created in the step of first creating, until reaching the upper end or a vicinity of the upper end,
placing the upper region on the lower region at a position of the horizontal plane, and
joining the cutting paths of the step of first creating and the cutting paths of the step of second creating through the horizontal plane, by connecting the upper region and the lower region to each other at the horizontal plane by radiating one of a laser beam and an electron beam from outside to a position of the horizontal plane and its neighborhood by melting the position and solidifying the position after melting in order to form the three-dimensional shaped product.

2. A method for automatic creation of a cutting path in an interior space of a three-dimensional shaped product formed in a CAD/CAM system in which a program is designed for each of the steps of forming lamination of a powder according to a squeegee spraying the powder and moving on the sprayed powder for providing the powder surface flat state, sintering by radiating one of a laser beam and an electron beam to one or a plurality of the laminated powder layers in a shaping region of the three-dimensional shaped product by melting radiated positions and solidifying the radiated positions after melting and cutting by traveling of a cutting tool, that are necessary to create the three-dimensional shaped product, comprising the steps of:
defining a horizontal plane at a position separating the upper region and the lower region,
first creating, in a lower region of the horizontal plane, data of horizontal cutting paths with a standard on positions according to height direction on interior wall sections, that are set by the program for said steps of forming lamination and sintering, from a location at the lower end or a vicinity of the lower end, at locations set successively toward an upper side with every cutting width of the cutting tool along a vertical direction,
when creation of each horizontal cutting path in the step of first creating has reached the horizontal plane or a location at a distance that is shorter than the cutting width along the vertical direction from the horizontal plane, while creating a horizontal cutting path on the horizontal plane, thereafter second creating data of horizontal cutting paths with a standard on positions according to height direction on interior wall sections, that are set by the program for said steps of forming lamination and sintering, in the upper region of the horizontal plane, at locations set successively toward the upper side with every cutting width of the cutting tool along the vertical direction, from a location that is higher by the cutting width than the last cutting path created in the step of first creating, until reaching the upper end or a vicinity of the upper end,
joining the cutting paths of the step of first creating and the cutting paths of the step of second creating through the horizontal plane, after deleting the horizontal cutting path on the horizontal plane,
wherein, for forming the three-dimensional shaped product, it is planned that the lower region of the horizontal plane and the upper region of the horizontal plane are divided with each other, and the forming lamination, the sintering, and the cutting of the lower region and these of the upper region are executed independently, and that the upper region is put on the lower region at a position of the horizontal plane, and these regions are connected with each other by radiating one of a laser beam and an electron beam from outside to a position of the horizontal plane and its neighborhood by melting the position and solidifying the position after melting.

3. The method for automatic creation of a cutting path in the interior space of a three-dimensional shaped product according to claim 1, wherein the step of first creating includes creating the cutting paths with the premise that a standard cutting tool is used for a lower end surface which is set by the program, before the horizontal cutting paths are created.

4. The method for automatic creation of a cutting path in the interior space of a three-dimensional shaped product according to claim 1, wherein the step of second creating includes creating the cutting paths with the premise that an undercut tool is used for an upper end surface which is set by the program, after the horizontal cutting paths are created.

5. The method for automatic creation of a cutting path in the interior space of a three-dimensional shaped product according to claim 1, wherein, when the shape is comprised such that a horizontal direction width of the interior wall section gradually narrows along an upward direction in a partial region in the vertical direction, further including the step of creating horizontal cutting paths with the premise that an undercut tool is used in the regions of the interior wall section that exhibit the shape.

6. The method for automatic creation of a cutting path in the interior space of a three-dimensional shaped product according to claim 1, wherein, when the shape is comprised such that a horizontal direction width of the interior wall section gradually narrows along an upward direction in a partial region in the vertical direction, while the interior wall section is vertical at other height regions, further including the step of creating the horizontal cutting paths in each of the steps of defining, first creating, second creating and joining after inverting upper end locations and lower end locations.

7. The method for automatic creation of a cutting path in the interior space of a three-dimensional shaped product according to claim 1, wherein, when facing interior wall sections are in a parallel slanting state in all regions along the vertical direction, further including the step of creating the horizontal cutting paths in each of the steps of defining, first creating, second creating and joining after carrying out coordinate transformation from a slanting direction to the vertical direction in all regions of the three-dimensional shaped product.

8. The method for automatic creation of a cutting path in the interior space of a three-dimensional shaped product according to claim 2, wherein the step of first creating includes creating the cutting paths with the premise that a standard cutting tool is used for a lower end surface which is set by the program, before the horizontal cutting paths are created.

9. The method for automatic creation of a cutting path in the interior space of a three-dimensional shaped product according to claim 2, wherein the step of second creating includes creating the cutting paths with the premise that an undercut tool is used for an upper end surface which is set by the program, after the horizontal cutting paths are created.

10. The method for automatic creation of a cutting path in the interior space of a three-dimensional shaped product according to claim 2, wherein, when the shape is comprised such that a horizontal direction width of the interior wall section gradually narrows along an upward direction in a partial region in the vertical direction, further including the step of creating horizontal cutting paths with the premise that an undercut tool is used in the regions of the interior wall section that exhibit the shape.

11. The method for automatic creation of a cutting path in the interior space of a three-dimensional shaped product according to claim 2, wherein, when the shape is comprised such that a horizontal direction width of the interior wall section gradually narrows along an upward direction in a partial region in the vertical direction, while the interior wall section is vertical at other height regions, further including the step of creating the horizontal cutting paths in each of the steps of defining, first creating, second creating and joining after inverting upper end locations and lower end locations.

12. The method for automatic creation of a cutting path in the interior space of a three-dimensional shaped product according to claim 2, wherein, when facing interior wall sections are in a parallel slanting state in all regions along the vertical direction, further including the step of creating the horizontal cutting paths in each of the steps of defining, first creating, second creating and joining after carrying out coordinate transformation from a slanting direction to the vertical direction in all regions of the three-dimensional shaped product.

13. The method for automatic creation of a cutting path in the interior space of a three-dimensional shaped product according to claim 1, further comprising the steps of:
positioning the lower region and the upper region with connecting state on a table which is adapted to rotate along a center axis to execute radiation for all positions of the horizontal plane and its neighborhood;
using a first one of the laser beam and the electron beam radiating instrument for sintering; and
using a different second one of the laser beam and the electron beam radiating instrument for radiating the position of the horizontal plane and its neighborhood from outside of the horizontal plane.

14. The method for automatic creation of a cutting path in the interior space of a three-dimensional shaped product according to claim 1, further comprising the steps of:
positioning the lower region and the upper region with connecting state on a table which is adapted to rotate along a center axis to execute radiation for all positions of the horizontal plane and its neighborhood;
using a mirror for reflecting one of the laser beam and the electron beam for sintering to the position of horizontal plane and its neighborhood from outside of the horizontal plane.

15. The method for automatic creation of a cutting path in the interior space of a three-dimensional shaped product according to claim 1, further comprising the steps of:
using a first one of the laser beam and the electron beam for sintering;
using a plurality N of different second ones of a laser beam and an electron beam for radiating the position of the horizontal plane and its neighborhood outside of the horizontal plane with identical angularly spaced positions along the horizontal direction around a center axis along a perpendicular direction of the lower region and the upper region where N≥3, and
rotating each of the plurality N of ones of the laser beam and the electron beam along the horizontal direction with an angular range of 360°/N.

16. The method for automatic creation of a cutting path in the interior space of a three-dimensional shaped product according to claim 1, further comprising the steps of:
using a plurality N of mirrors for reflecting one of the laser beam and the electron beam for sintering to the position of the horizontal plane and its neighborhood from outside of the horizontal plane in order with identical angled positions along the horizontal direction around a center axis along a perpendicular direction of the lower region and the upper region where N≥3 and
rotating each of the plurality N of the mirrors along the horizontal direction with an angular range of 360°/N.

17. The method for automatic creation of a cutting path in the interior space of a three-dimensional shaped product according to claim 2, further comprising the steps of:
positioning the lower region and the upper region with connecting state on a table which is adapted to rotate along a center axis to execute radiation for all positions of the horizontal plane and its neighborhood;
using a first one of the laser beam and the electron beam radiating instrument for sintering; and
using a different second one of the laser beam and the electron beam radiating instrument for radiating the position of the horizontal plane and its neighborhood from outside of the horizontal plane.

18. The method for automatic creation of a cutting path in the interior space of a three-dimensional shaped product according to claim 2, further comprising the steps of:
positioning the lower region and the upper region with connecting state on a table which is adapted to rotate along a center axis to execute radiation for all positions of the horizontal plane and its neighborhood;
using a mirror for reflecting one of the laser beam and the electron beam for sintering to the position of horizontal plane and its neighborhood from outside of the horizontal plane.

19. The method for automatic creation of a cutting path in the interior space of a three-dimensional shaped product according to claim 2, further comprising the steps of:
using a first one of the laser beam and the electron beam for sintering;
using a plurality N of different second ones of a laser beam and an electron beam for radiating the position of the horizontal plane and its neighborhood outside of the horizontal plane with identical angularly spaced positions along the horizontal direction around a center axis along a perpendicular direction of the lower region and the upper region where N≥3, and
rotating each of the plurality N of ones of the laser beam and the electron beam along the horizontal direction with an angular range of 360°/N.

20. The method for automatic creation of a cutting path in the interior space of a three-dimensional shaped product according to claim 2, further comprising the steps of:
using a plurality N of mirrors for reflecting one of the laser beam and the electron beam for sintering to the position of the horizontal plane and its neighborhood from outside of the horizontal plane in order with identical angled positions along the horizontal direction around a center axis along a perpendicular direction of the lower region and the upper region where N≥3 and
rotating each of the plurality N of the mirrors along the horizontal direction with an angular range of 360°/N.

21. The method for automatic creation of a cutting path in the interior space of a three-dimensional shaped product according to claim 1, further comprising the step of cutting an upper end surface of the upper region is executed after inverting upper end locations and lower end locations.

22. The method for automatic creation of a cutting path in the interior space of a three-dimensional shaped product according to claim 2, further comprising the step of cutting an upper end surface of the upper region is executed after inverting upper end locations and lower end locations.
